(19) United States
(12) Patent Application Publication
(10) Pub. No.: US 2008/0263335 A1
(43) Pub. Date: Oct. 23, 2008

(54) Representation of Modal Intervals within a Computer

(76) Inventor: Nathan T. Hayes, Minneapolis, MN (US)

Correspondence Address: NAWROCKI, ROONEY & SIVERTSON;SUITE 401, BROADWAY PLACE EAST, 3433 BROADWAY STREET NORTHEAST, MINNEAPOLIS, MN, 554133009, US

(21) Appl. No.: 12/088,382

(22) PCT Filed: Oct. 2, 2006
(86) PCT No.: PCT/US06/38579

§ 371 Date: Mar. 27, 2008

Related U.S. Application Data
(60) Provisional application No. 60/723,216, filed on Oct. 3, 2005.

(51) Int. Cl. G06F 15/00; G06F 9/00

(52) U.S. Cl. 712/222; 712/E09.001

(57) ABSTRACT

A modal interval representation having improved computational utility is provided. The modal interval representation generally includes a binary quantifier, and a set theoretical interval for select permutations of marks of a pair of marks of an IEEE standard 754 digital scale. The set theoretical interval includes combinations of real numbers, infinities, signed zeros, and pseudo-numbers, with select permutations of the marks comprising bounded, unbounded, pointwise and indefinite modal intervals.

This is an international application filed under 35 USC §363 claiming priority under 35 U.S.C. §119(e) (1), of U.S. provisional application Ser. No. 60/723,216, having a filing date of Oct. 3, 2005, said application incorporated herein by reference in its entirety.

### TECHNICAL FIELD

The present invention generally relates to methods associated with the execution of arithmetic operations on modal intervals within a computing/processing environment, more particularly, the present invention relates to an improved system and method of representing modal intervals within a computing environment to facilitate reliable and efficient computation of modal interval calculations.

### BACKGROUND OF THE INVENTION

The common and popular notion of interval arithmetic is based on the fundamental premise that intervals are sets of numbers and that arithmetic operations can be performed on these sets. Such interpretation of interval arithmetic was initially advanced by Ramon Moore in 1957, and has been recently promoted and developed by interval researchers such as Eldon Hansen, William Walster, Guy Steele and Luc Jaulin. This is the so-called “classical” interval arithmetic, and it is purely set-theoretical in nature.

A set-theoretical interval is a compact set of real numbers [a,b] such that a≦b. The classical interval arithmetic operations of addition, subtraction, multiplication and division combine two interval operands to produce an interval result such that every arithmetical combination of numbers belonging to the operands is contained in the interval result. This leads to programming formulas made famous by classical interval analysis, and which are discussed at length in the interval literature.

Translating interval programming formulas into practical computational methods that can be performed within a computer remains a topic of research in the interval community. The Institute of Electrical and Electronics Engineers Standard for Binary Floating-Point Arithmetic (i.e., IEEE standard 754), which specifies exceptionally particular semantics for binary floating-point arithmetic, enjoys pervasive and worldwide use in modern computer hardware. As a result, efforts have been focused on creating practical interval arithmetic implementations that build on the reputation and legacy of this standard.

Creating practical implementations, however, is not without its perils. The problems begin with choosing a suitable representation in a computer for the intervals. An obvious choice is to use two floating-point numbers to represent the endpoints of an interval. What is not obvious is how to handle complications which arise in conditions such as overflow, underflow and exceptional combinations of operands.

IEEE standard 754 specifies bit-patterns to represent real floating-point numbers as well as −∞, +∞, −0, +0 and the pseudo-numbers, which are called NaNs (i.e., Not-a-Number). Although the standard defines precise rules for the arithmetical combination of all permutations of bit-patterns of two floating-point values, the translation of these rules into arithmetical combinations of intervals is unclear. As is widely held, mapping the interval endpoints onto the set of IEEE floating-point representations is both desirable and challenging.

With great debate, and various levels of success, set-theoretical interval researchers have developed different representation methods for intervals. In the paper “Interval Arithmetic: from Principles to Implementation,” Hickey, et. al., Journal of the ACM, Vol. 48.5, 2001, p. 1038-1068, incorporated herein by references, the authors discuss and summarize the many different implementations and viewpoints of the interval community on this subject. In another example, Walster defines a sophisticated mapping of set-theoretical intervals to IEEE standard 754 in U.S. Pat. No. 6,658,443, which is also incorporated herein by reference.

Consensus in the interval community remains divided. As an example, the methods of both Walster and Hickey require special treatment of −0 and +0 as distinct values. However, others, like Jorge Stolfi, reject such special treatments of −0, and generally comment that while it is possible to concoct examples where such special treatment saves an instruction or two, in the vast majority of applications doing so is an annoying distraction, and a source of subtle bugs.

This observation is closely related to a problem that plagues representations of intervals in the prior art: a lack of closure or completeness. Such representations do not specify semantics for all possible bit-patterns of intervals represented by the set of IEEE floating-point numbers.

For example, in the 1997 monograph “Self-Validated Numerical Methods and Applications,” Stolfi describes a system and method for representing set-theoretical intervals within a computer, but not all possible bit-patterns are accounted for. The computational programs therein assume such bit-patterns will not appear as an operand. If the user does not take great care to submit only the valid subset of operands to the computational program, unreliable results are the inevitable and unfortunate consequence.

The same problem or shortcoming is found in the representations of Walster and Hickey. In both cases, true mathematical zero must be represented as the interval [−0, +0]. By construction, the intervals
[−0,−0] [+0,+0] [+0,−0]
   are invalid and have no semantical meaning. If great care is not taken to ensure these intervals do not appear in a computation, unreliable results occur.

Similarly, semantics do not exist, or are unclear for some intervals involving infinities. As an example, Walster's method is ambiguous on the treatment of the intervals
[−∞,−∞] [+∞,+∞]
   whereas Stolfi unequivocally identifies such intervals as invalid.

Last but hardly least, computational simplicity is another goal that has so far been elusive. For example, the method of Walster requires significant amounts of special software instruction to create an implementation that works properly with existing hardware, with such requirement no doubt an obstacle to creating a practical implementation and/or commercial product embodying same.

In 2001, Miguel Sainz and other members of the SIGLA/X group at the University of Girona, Spain, introduced a new branch of interval mathematics known as “modal intervals.” Unlike the classical view of an interval as a compact set of real numbers, the new modal mathematics considers an interval to be a quantified set of real numbers.

As a practical consequence, a modal interval is comprised of a binary quantifier and a set-theoretical interval. In the modal interval literature, an apostrophe is used to distinguish a set-theoretical interval from a modal interval, so if Q is a quantifier and X′ is a purely set-theoretical interval, then X=(Q, X′) is a modal interval. For this reason, it is easy to see that modal intervals are a true superset of the classical set-theoretical intervals. At the same time, the quantified nature of a modal interval provides an extra dimension of symmetry not present in the classical set-theoretical framework.

This difference allows the modal intervals to solve problems out of the reach of their classical counterparts. Just as the real expression 3+x=0 has no meaning without negative numbers, it can be shown that the interval expression [1,2]+X=[0,0] has no meaning without quantified (i.e., modal) intervals.

The quantified nature of a modal interval comes from predicate logic, and the value of a quantifier may be one of the fundamental constructions ∃ or ∀, that is, “existential” or “universal.” The symbols ∃ and ∀ are commonly read or interpreted as “there exists” and “for all,” respectively.

The article “Modal Intervals,” M. Sainz, et. al., Reliable Computing, Vol. 7.2, 2001, pp. 77-111, provides an in-depth introduction to the notion of modal intervals, how they differ from the classical set-theoretical intervals, and upon what mathematical framework they operate; the article is also incorporated herein by reference.

Considering that modal intervals are a new mathematical construct, a new representation for modal intervals within a computer is needed. The large body of work dealing with representations of set-theoretical intervals is largely unhelpful due to the fact that modal intervals' are mathematically more complex.

A software program for modal intervals available from the University of Girona provides a starting point or benchmark. The designers of that system avoid several implementation complexities by limiting modal intervals to those comprised only of finite and bounded endpoints. Such a representation is relatively simple to implement in a computer, but it lacks reliable overflow tracking, which can lead to pessimism and even unreliable results. This is particularly true when computations are performed in a mixed-mode environment, that is, when calculations on numbers represented by different digital scales are mixed within a lengthy computation. This occurs, for example, when some intervals in a computation are represented by 32-bit floating-point values while others have 64-bit representations.

For this reason, the previously discussed pitfalls which plague the set-theoretical representations apply to modal intervals. When considering an improved representation for modal intervals, there is also the burden of supporting mathematical semantics required by modal intervals which are not present in a set-theoretical interval system, or vice-versa. Hickey defines [0,1]/[0,1]=[0,+∞] as a valid example of an expression which represents the division of two set-theoretical intervals containing zero. Such semantics do not exist in the context of modal intervals and are therefore unsuitable for, and hardly compatible with, a modal interval representation.

More recently, invalid operations of IEEE arithmetic in relation to the classical set-theoretical interval arithmetic have been addressed by Steele, Jr. in U.S. Pat. No. 7,069,288, incorporated herein by reference. In-as-much as improved results are arguably provided, the improved result values are not compatible with an unbounded modal interval framework, more particularly, Steele does not consider existential or universal quantifiers. Furthermore, and also of significance, the improved results identified by Steele depend on a rounding mode. For example, Steele defines

(+∞)+(−∞)=+∞

when rounding towards positive infinity and

(+∞)+(−∞)=˜∞

when rounding in the opposite direction.

Thus, with heretofore known classical representations of intervals within a computer, e.g., those of Hansen, Walster, Steele, etc., providing absolutely no hope for compatibility with a modal interval representation, there remains a need for an improved representation of a modal interval in furtherance of improved computer executable computations and/or processing. In-as-much as there exists alternate mechanisms, systems, methods, techniques for the representation of modal intervals (e.g., software based representations of Sainz et al.), such representations leave room for improvement. More particularly, there remains a need for a closed mapping of IEEE standard 754 to unbounded modal intervals, i.e., a representation which selectively assigns a semantical meaning for every modal interval comprised of two marks of a digital scale where each mark is a real number, a signed infinity, a signed zero, or a NaN.

### SUMMARY OF THE INVENTION

The present invention provides a novel representation that satisfies both the mathematical semantics of modal interval arithmetic as well as the computational requirements of a practical and efficient implementation. The preferred embodiment of the present invention advantageously resides within a modal interval processor as described in applicant's pending international application ser. no. PCT/US06/12547 filed Apr. 5, 2006 entitled MODAL INTERVAL PROCESSOR, and incorporated herein by reference.

The modal interval processor receives a representation of a first and a second modal interval, performs a modal interval arithmetic operation, and returns a modal interval result. To perform the arithmetic operation, the modal interval processor uses mathematical semantics for bounded, unbounded, pointwise, and indefinite modal intervals as described in the present invention, including the proper handling of exceptional cases, which is also described herein. In another embodiment of the present invention, special instruction is provided to a floating-point processor, thereby emulating the aforementioned function of the modal interval processor.

By combination of these parts and methods, the present invention produces, among other things, the following novelties: a closed mapping of the modal intervals to IEEE standard 754; representation and semantics for unbounded modal intervals; overflow management for modal intervals that is computationally and mathematically correct; and, reliable support for mixed-mode computations on modal intervals.

### BRIEF DESCRIPTION OF THE DRAWINGS

FIG. 1 is a table presenting improved representations of modal intervals within a computer;

FIG. 2 is a tabulated summary of improved results for unbounded modal interval addition and subtraction;

FIG. 3 is a tabulated summary of improved results for unbounded modal interval multiplication; and,

FIG. 4 is a tabulated summary of improved results for unbounded modal interval division.

### DETAILED DESCRIPTION OF THE INVENTION

The present invention operates upon a digital scale. Because the set of real numbers, R, is uncountable, a computer must perform calculations upon a finite approximation of R, and a digital scale is such an approximation. Each mark in a digital scale is represented in a computer by a bit-pattern and corresponds to a particular element of R. The spacing between marks on a digital scale might not be uniform, but every digital scale is characterized by a mark which represents a largest and a smallest real number.

The bit-pattern of marks in a digital scale may use any convention. Integers, scaled integers, fractional integers and floating-point values are all examples.

Arithmetic operations performed on a digital scale may result in a number that does not correspond exactly to any mark. If this occurs, an approximated result is said to be “correctly rounded” if the exact result is rounded to the nearest mark according to a specified rounding convention.

Overflow is a condition that occurs when a correctly-rounded result of an arithmetic operation exceeds the largest or smallest mark of the digital scale. To help track overflow in a reliable manner, a digital scale can specify the two special marks −∞ and +∞ to represent, respectively, overflow of the smaller or larger end of the digital scale.

Conversion of marks between digital scales can also cause overflow. This is most likely to occur when marks from a large digital scale are converted to a smaller digital scale. Reliable overflow tracking requires that −∞ and +∞ always convert exactly between any two digital scales.

The present invention is compatible with any digital scale supporting correctly-rounded arithmetic, reliable overflow tracking, and marks for the numbers −1, 0 and +1. To work properly in mixed-mode computations where marks from different digital scales are combined in arithmetical operations, it should always be the case that the marks −∞, −1, 0, +1 and +∞ convert exactly, that is, without rounding, between any two digital scales. IEEE standard 754 meets all these requirements, and the remainder of this disclosure makes the assumption that it is the digital scale of the implementation, however, it need not be so limited. The application of the present invention to other digital scales meeting the listed criteria should be obvious, and likewise are contemplated.

### Bounded Modal Intervals

A modal interval is comprised of or characterized by two fundamental elements: a quantifier and a set-theoretical interval. The quantified nature of a modal interval comes from predicate logic, and the value of a quantifier may be one of the fundamental constructions ∃ or ∀, that is, “existential” or “universal.” The symbols ∃ and ∀ are commonly read or interpreted as “there exists” and “for all,” respectively.

In a computer, a modal interval is comprised of a first and a second mark of a digital scale. If both marks are real numbers, the set-theoretical part of the modal interval is the compact set of all real numbers between and including the marks; the quantifier is deduced by the relative signed magnitude of the two marks. If the first mark is less-than the second mark, the quantifier is existential. If the first mark is greater-than the second mark, the quantifier is universal. If the two marks are equal, the modal interval is a point, and such modal interval represents a single real number that has, simultaneously, a quantified modality of existential and universal. Such is the definition of a modal interval according to the prior art.

Note that a great deal of classical literature on set-theoretical intervals uses a similar convention to represent a non-compact set of real numbers known as an “exterior” set-theoretical interval, which is the union of two semi-infinite set-theoretical intervals. For example, if a<b, the interval [b,a] is treated in the classical literature as an “exterior” set-theoretical interval. This is not to be confused with the modal interval convention [b,a] which indicates a “universal” modal interval. It is unfortunate that the notations are identical even though the semantics or meaning are completely different, and fundamentally independent. The subject disclosure does not use the “exterior” convention of the classical interval literature; all uses of such notation represent the modal interval interpretation.

### Unbounded Modal Intervals

The treatment of modal intervals in the prior art, both from a mathematical and a, computational perspective, is limited exclusively to bounded modal intervals. A novelty of the present invention begins with the introduction and treatment of unbounded modal intervals.

As with bounded modal intervals, an unbounded modal interval is represented in a computer by a fist and a second mark of a digital scale. In the case of an unbounded modal interval, at least one mark is infinity.

Strictly speaking, the presence of infinity in the representation of an unbounded modal interval is a token which indicates an unbounded endpoint; the actual infinity is not contained in the modal interval. Therefore the unbounded modal interval is different from the “extended-real” modal interval. The former contains only real numbers, while the latter contains the infinity, which is not a real number.

As with bounded modal intervals, the quantifier of an unbounded modal interval is deduced by the relative signed magnitude of the two marks. If both marks are infinities of the same sign, the modal interval is a point, a single real number unbounded in signed magnitude, the sign of the magnitude being the same as the two same-signed infinities. Such an unbounded point has a simultaneous quantified modality of existential and universal, just as is the case for bounded modal interval points.

### Special Pointwise Modal Intervals

If both marks of the modal interval are infinities of the same sign, this is one case of a special pointwise modal interval. In this case, the two infinites are tokens which semantically indicate a single real number unbounded in signed magnitude. The sign of the magnitude is equal to the sign of the two same-signed infinities.

The other special cases are the modal intervals comprised entirely of signed zeros. IEEE standard 754 specifies distinct marks for −0 and +0, which are both aliases for true mathematical zero. The present invention adopts this convention, as well as' the general position of Stolfi regarding the special treatment of −0.

As such, representation of true mathematical zero has four aliases in the modal interval representation, one alias for each combination of the four possible permutations of signs between the two zeros. Semantically, all four aliases represent mathematical zero.

As should be obvious, this also means that bounded and unbounded modal intervals which contain the mark −0 or +0 in one endpoint is an alias for the same modal interval containing the same zero of complimentary sign in the same endpoint. For example, the modal intervals [12,+0] and [12,−0] are aliases of each other.

### Indefinite Modal Intervals

So far, the representation has assigned a semantical meaning for every modal interval comprised of two marks, where each mark represents a real number, a signed infinity or a signed zero.

IEEE standard 754 also defines the NaNs, i.e., pseudo-numbers. If at least one mark of a modal interval representation is a NaN, then the modal interval is indefinite.

Indefinite modal intervals serve the same purpose as the NaNs do in IEEE standard 754. That is, the indefinite modal interval can be used to propagate errors through a computation. The result of any modal interval operation on an indefinite modal interval operand must be an indefinite modal interval result.

In regard to modal interval relations, it is always true that an indefinite modal interval is not equal to itself or any other modal interval. All other modal interval relations involving an indefinite modal interval are false.

### Unbounded Addition

A closed mapping of IEEE standard 754 to the representation of modal intervals has been given. That is, the representation has assigned a semantical meaning for every modal interval comprised of two marks, where each mark represents a real number, a signed infinity, a signed zero, or a NaN. This mapping provides support for unbounded modal intervals. The prior art, however, does not consider unbounded modal intervals or how to perform arithmetic operations on them. What remains to be done in the present invention is to specify the operational semantics of unbounded modal interval arithmetic.

Consider an example of modal interval addition, [3,+∞]+[−∞,2]. Semantically speaking, this represents addition of two unbounded existential modal intervals. Using IEEE arithmetic to calculate the modal interval addition provides the result

[3+(−∞),(+∞)+2]=[−∞,+∞].

Because the infinity in each operand represents a real number of unbounded signed magnitude, the sums of the result are likewise unbounded. In this case, using IEEE arithmetic to calculate the result provides the correct unbounded answer.

But consider a similar example where the modality of the first operand is universal, that is, [+∞,3]+[−∞,2]. In this case, using IEEE arithmetic to calculate the modal interval addition provides the result

[(+∞)+(−∞),3+2]=[NaN,5].

The NaN in the result is a consequence of an invalid operation. Specifically, the arithmetic operation (+∞)+(−∞) is invalid, so the IEEE arithmetic specifies NaN as the result. In this case, using IEEE arithmetic to calculate the unbounded result does not work.

What is wrong here? At this point, it is critically important to remember that due to the representation of the present invention, the infinity is not actually contained in the modal interval; it is only a token to indicate a real number of unbounded signed magnitude. This is in contrast to IEEE arithmetic, which treats the infinity as a true infinite value, that is, IEEE arithmetic does not treat the infinity as a real number. Performing an IEEE arithmetic operation directly on the infinities in the first example provides the correct unbounded result, but this is only a fortunate coincidence. As the second example shows, such a computational trick does not always provide the correct answer.

Remembering again that the presence of infinites in the representation of a modal interval is only a token for an unbounded value, a re-examination of the two examples using substitution is helpful, and revealing.

In the first example (i.e., [3, +∞]+[−∞, 2]), substituting the infinities for increasingly large real magnitudes reveals the following trend:

$$\begin{matrix}[ 3 + ( - 1000 ) , ( + 1000 ) + 2 ] = [ - 997 , + 1002 ] \\ [ 3 + ( - 1000000 ) , ( + 1000000 ) + 2 ] = [ - 999997 , + 1000002 ] \\ [ 3 + ( - 1000000000 ) , ( + 1000000000 ) + 2 ] = [ - 999999997 , + 1000000002 ] .\end{matrix}$$

As increasingly large magnitudes are substituted for the infinities, the sums will eventually overflow the digital scale, providing a result of [−∞,+∞] to represent an unbounded interval. In this case, it is a coincidence that performing IEEE arithmetic directly on the unbounded endpoints provides the desired unbounded result.

In the second example (i.e., [+∞, 3]+[−∞, 2]), substituting the infinities for increasingly large real magnitudes reveals the following trend

$$\begin{matrix}[ ( + 1000 ) + ( - 1000 ) , 3 + 2 ] = [ 0 , 5 ] \\ [ ( + 1000000 ) + ( - 1000000 ) , 3 + 2 ] = [ 0 , 5 ] \\ [ ( + 1000000000 ) + ( - 1000000000 ) , 3 + 2 ] = [ 0 , 5 ] .\end{matrix}$$

As increasingly large magnitudes are substituted for the infinities, the sums of equal magnitude continually cancel each-other out, resulting in the correct modal interval result of [0,5]. In this case, the computational trick of performing IEEE arithmetic directly on the unbounded endpoints does not work.

As a conclusion to be drawn from these examples, it is a fortunate coincidence that addition of unbounded modal intervals can be calculated properly using IEEE arithmetic for any operation that is not invalid. Specifically, (+∞)+(−∞) and (−∞)+(+∞) are the invalid operations of IEEE addition. In these cases, special instruction must return an improved result of +0. Likewise, the same conclusions and similar special cases are reached for subtraction of unbounded modal intervals.

### Conversion of Digital Scales

An important point regarding the present invention can be reinforced by considering further the example of unbounded modal interval addition. To with, in a software implementation of modal intervals available from the University of Girona, unbounded modal intervals do not have any representation or implementation. As a consequence, unbounded modal intervals can only be approximated by using very large bounded modal intervals.

Consider again the modal interval operation [+∞,3]+[−∞,2]. If magnitudes of the same approximation are substituted for the infinities, it has been shown that the correct result of [0,5] is obtained. But if magnitudes of different approximation are substituted for the infinites, the result becomes pessimistic. For example,

$$\begin{matrix}[ ( + 999 ) + ( - 1001 ) , 3 + 2 ] = [ - 2 , 5 ] \\ [ ( + 9999 ) + ( - 1000001 ) , 3 + 2 ] = [ - 990002 , 5 ] \\ [ ( + 99999 ) + ( - 1000000001 ) , 3 + 2 ] = [ - 999900002 , 5 ] .\end{matrix}$$

Such pessimism occurs in modal interval arithmetic operations when the endpoints of the unbounded modal intervals are approximated with different magnitudes.

But pessimism is not the worst problem which can occur. In some cases, the computation is totally unreliable. For example, if the magnitudes of approximation in the previous example are exchanged,

$$\begin{matrix}[ ( + 1001 ) + ( - 999 ) , 3 + 2 ] = [ 2 , 5 ] \\ [ ( + 1000001 ) + ( - 9999 ) , 3 + 2 ] = [ 990002 , 5 ] \\ [ ( + 1000000001 ) + ( - 99999 ) , 3 + 2 ] = [ 999900002 , 5 ] .\end{matrix}$$

The correct answer, [0,5], is not even a subset of any computed result. This represents a total failure of the modal interval containment theory. In other words, the computed results are bogus.

This problem frequently occurs in existing computational programs which use only the bounded modal intervals. In this case, approximations of unbounded values are generally initialized with a common value. During computation, however, accumulations of arithmetical operations cause the approximation to “drift” randomly away from the original common value. Eventually all or most of the approximations are no longer equal to each other, and pessimism or unreliability, as previously described, are introduced into the computation.

Such a problem is exacerbated when computations using only the bounded modal intervals operate on mixed digital scales. Conversion between digital scales often results in catastrophic rounding errors, causing dramatic changes to the magnitude of unbounded approximations. As a consequence, the changes in magnitude can introduce staggering amounts of pessimism or even total failure into a computation.

Typically, conversion from a larger digital scale to a smaller digital scale will also result in an overflow condition. Existing computational programs based only on the bounded modal intervals have no option but to terminate, or raise an exception.

The present invention solves all these problems by introducing the unbounded modal intervals, along with a reliable overflow tracking. Without these novelties, problems due to pessimism, unreliable computations, and a lack of overflow tracking are difficult, if not impossible, to avoid.

### Unbounded Multiplication

As in the case of addition, the case of unbounded modal interval multiplication is considered.

Again, substitution of the infinites by increasingly large real magnitudes provides a mechanism to “see” the correct results. Performing this analysis yields the same conclusion as before, that the IEEE arithmetic conveniently computes proper results for any operation that is not invalid. Specifically, (±∞)×(±0) and (±0)×(±∞) are the invalid operations of IEEE multiplication. In these cases, special instruction must return an improved result of ±0. For total correctness, the sign of the result should be equal to the sign of the product of the signs of the operands.

### Unbounded Division

As in the cases of addition and multiplication, the case of unbounded modal interval division is considered.

Again, substitution of the infinites by increasingly large real magnitudes provides a mechanism to see the correct results. Performing this analysis yields the same conclusion as before, that the IEEE arithmetic conveniently computes proper results for any operation that is not invalid. Specifically, (±∞)/(±∞) are the invalid operations of IEEE division. In these cases, special instruction must return an improved result of ±1. The sign of the result must be equal to the sign of the product of the signs of the operands.

Division by zero is invalid for unbounded modal intervals, as it is in the case of the bounded modal intervals. By default, the IEEE division operation returns an infinite result when the denominator is a zero and the numerator is not a NaN, but IEEE standard 754 allows the user to change this default behavior so the result is a NaN. For the sake of the present invention, it should always be the case that division by zero results in a NaN.

### CONCLUSION

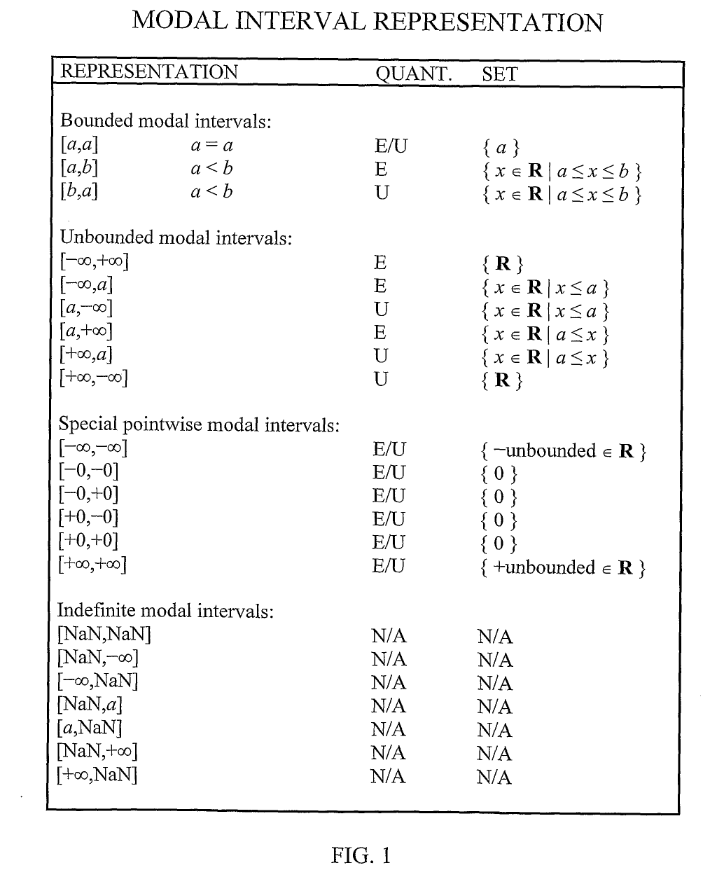

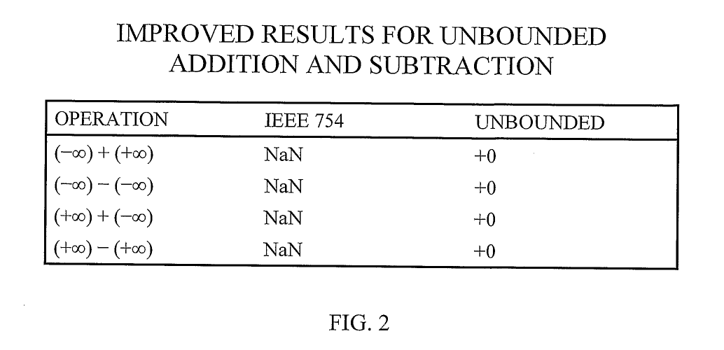

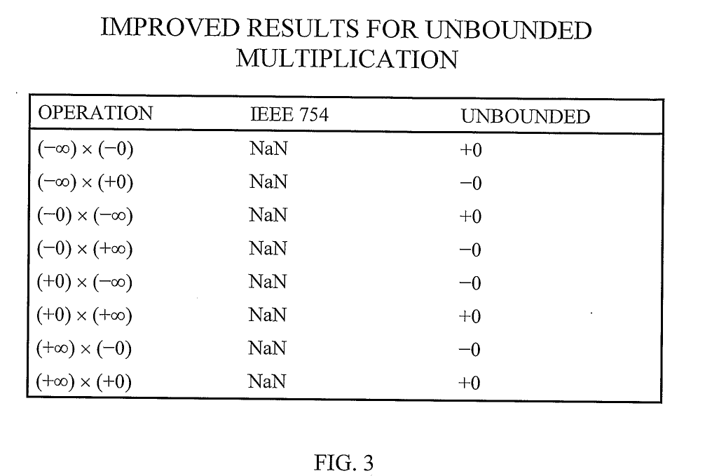

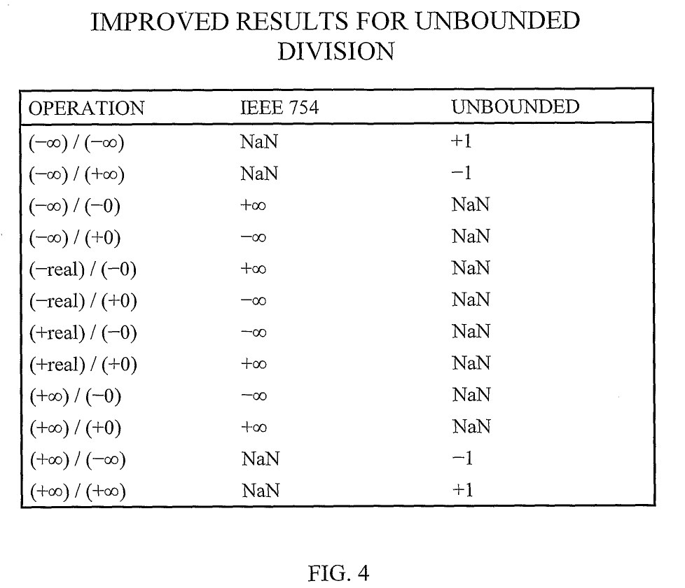

The present invention, among other things, introduces a system and method for representing unbounded modal intervals within a computer, a summary of which is presented as FIG. 1. A closed mapping of IEEE standard 754 to the unbounded modal intervals is provided, more particularly, a representation which assigns a semantical meaning for every modal interval comprised of two marks, where each mark is a real number, a signed infinity, a signed zero, or a NaN, is provided. The present invention further identifies the new and improved results of unbounded modal interval arithmetic, a summary of which is presented in FIGS. 2-4.

Via combinations of the aforementioned features, the present invention provides a correct and efficient overflow tracking system and method for unbounded modal interval calculations. This facilitates at last the reliable calculation of modal interval arithmetical operations in a mixed-mode environment where modal intervals may be represented by different digital scales.

Furthermore, it has been demonstrated that the system and method of the present invention can be implemented on existing IEEE hardware with only a minimum amount of special instruction. The result is a highly efficient computational system that is compatible with existing hardware but which requires only small modifications to existing hardware in order to create a truly “native” hardware implementation. By virtue of these and other novelties, the present invention provides a new and ideal computational framework for the highly efficient and reliable evaluation of modal interval calculations.

Finally, in contradistinction to Steele, Jr., whose shortcomings were previously noted, the subject approach to representations of modal intervals within a computer are independent of a rounding mode. Furthermore, the value of each improved result identified by Steele is not compatible with the unbounded modal interval framework of the present invention; to with, the present invention defines

(+∞)+(−∞)=+0,

regardless of the rounding mode, that is, the magnitude of Steele's improved result (i.e., infinity) is not equal to the magnitude of the improved result of the present invention (i.e., zero). In-as-much as multiplication is the one case or scenario where the magnitude of Steele's improved result is “identical” to that of the present invention, the sign of Steele's improved result depends on rounding mode.

There are other variations of this invention which will become obvious to those skilled in the art. It will be understood that this disclosure, in many respects, is only illustrative. Although the various aspects of the present invention have been described with respect to various preferred embodiments thereof, it will be understood that the invention is entitled to protection within the full scope of the appended claims.

1. A modal interval representation having improved computational utility, said modal interval representation comprising a binary quantifier and a set theoretical set-theoretical interval for select permutations of marks of a pair of marks of an IEEE standard 754 digital scale comprising combinations of real numbers, infinities, signed zeros, and pseudo-numbers, said select permutations of said marks comprising bounded, unbounded, pointwise and indefinite modal intervals.

2. The modal interval representation of claim 1 wherein said unbounded modal interval permutation of said select permutations requires one mark of said marks of a pair of marks to comprise a token indicating an unbounded end point.

3. The modal interval representation of claim 2 wherein said unbounded modal interval permutation of said select permutations requires another mark of said marks of a pair of marks to comprise a token indicating an unbounded end point.

4. The modal interval representation of claim 3 wherein said token indicates a real number of unbounded signed magnitude.

5. The modal interval representation of claim 3 wherein said token is a signed infinity.

6. The modal interval representation of claim 1 wherein said pointwise modal interval permutation of said select permutations requires marks of said pair of marks to comprise a single, unbounded real number in signed magnitude.

7. The modal interval representation of claim 1 wherein said pointwise modal interval permutation of said select permutations requires marks of said pair of marks to comprise true mathematical zero.

8. The modal interval representation of claim 1 wherein said pointwise modal interval permutation of said select permutations requires marks of said pair of marks to comprise signed zeros.

9. The modal interval representation of claim 1 wherein said indefinite modal interval permutation of said select permutations requires at least one mark of said pair of marks to comprise a pseudo-number.

10. The modal interval representation of claim 1 wherein said indefinite modal interval permutation of said select permutations requires marks of said pair of marks to comprise pseudo-numbers.

11. A modal interval representation having improved computational utility, said modal interval representation comprising a binary quantifier and a set theoretical set-theoretical interval for a select pair of marks of a digital scale wherein at least one mark of said select pair of marks is a token indicating an unbounded end point.

12. The modal interval representation of claim 11 wherein only one mark of said select pair of marks is a token indicating an unbounded end point.

13. The modal interval representation of claim 12 wherein both marks of said select pair of marks are tokens indicating an unbounded end point.

14. The modal interval representation of claim 12 wherein both marks of said select pair of marks are signed tokens indicating an unbounded end point.

15. The modal interval representation of claim 14 wherein signs of said signed tokens are equivalent.

16. A computer executable interval computation method utilizing as inputs modal intervals comprised of a pair of a bit patterns associated with marks of a pair of marks of a digital scale, said method comprising:
a. representing bounded, unbounded, pointwise and indefinite modal intervals of said modal intervals within a computer system, the unbounded modal intervals characterized by a token representing an unbounded end point of at least a single mark of said pair of marks of a digital scale.

17. The method of claim 16 further comprising a step of tracking overflow conditions associated with a correctly rounded result of an arithmetic operation exceeding boundaries delimited by marks of said pair of marks of a digital scale.

18. The method of claim 17 wherein said tracking of the overflow conditions requires a token representing an unbounded end point of said representation of said unbounded modal intervals to be exactly convertible between digital scales of a variety of digital scales in furtherance of mixed digital scale computing.

19. A modal interval schema for a mapping of IEEE standard 754 digital scale to unbounded modal intervals, said schema comprising a representation for modal intervals comprised of two marks, each mark of said two marks selected from the group consisting of a real number, a signed infinity, a signed zero, or a pseudo number.

20. An improved interval computational methodology utilizing modal intervals wherein at least one mark of a pair of marks of an IEEE 754 digital scale comprises a token representing a single, unbounded real number in signed magnitude, said methodology comprising the step of substituting either a signed zero or a signed one for a NaN otherwise returned for arithmetic operations between marks representing end points of bounded and unbounded modal intervals, said arithmetic operations selected from the group consisting of addition, subtraction, multiplication or division.

21. The improved interval computational methodology of claim 20 wherein said token representing a single, unbounded real number in signed magnitude comprises an IEEE 754 mark negative infinity or positive infinity.

22. The improved interval computational methodology of claim 21 wherein a positive zero is substituted for invalid operations of IEEE addition.

23. The improved interval computational methodology of claim 22 wherein a positive zero is substituted for the NaN otherwise returned for addition of marks representing unbounded modal interval end points comprised of infinities of opposite sign.

24. The improved interval computational methodology of claim 21 wherein a positive zero is substituted for invalid operations of IEEE subtraction.

25. The improved interval computational methodology of claim 24 wherein a positive zero is substituted for the NaN otherwise returned for subtraction of marks representing unbounded modal interval end points comprised of equivalently signed infinities.

26. The improved interval computational methodology of claim 21 wherein a signed one is substituted for invalid operations of IEEE division.

27. The improved interval computational methodology of claim 26 wherein a positive one is substituted for the NaN otherwise returned for division of marks representing unbounded modal interval end points comprised of equivalently signed infinities.

28. The improved interval computational methodology of claim 27 wherein a negative one is substituted for the NaN otherwise returned for division of marks representing unbounded modal interval end points comprised of infinities of opposite sign.

29. The improved interval computational methodology of claim 21 wherein a signed zero is substituted for invalid operations of IEEE multiplication.

30. The improved interval computational methodology of claim 29 wherein a positive zero is substituted for the NaN otherwise returned for multiplication of marks representing bounded and unbounded modal interval end points, respectively, comprised of an equivalently signed zero and infinity, or of marks representing unbounded and bounded modal interval end points, respectively, comprised of an equivalently signed infinity and zero.

31. The improved interval computational methodology of claim 29 wherein a negative zero is substituted for the NaN otherwise returned for multiplication of marks representing bounded and unbounded modal interval end points, respectively, comprised of zero and infinity of opposite sign or of marks representing unbounded and bounded modal interval end points, respectively, comprised of an infinity and zero of opposite sign.

32. The modal interval representation of claim 2 wherein said token indicates a real number of unbounded signed magnitude.

33. The modal interval representation of claim 2 wherein said token is a signed infinity.

34. The modal interval representation of claim 11 wherein both marks of said select pair of marks are tokens indicating an unbounded end point.

35. The modal interval representation of claim 11 wherein both marks of said select pair of marks are signed tokens indicating an unbounded end point.

36. The modal interval representation of claim 35 wherein signs of said signed tokens are equivalent.

37. The method of claim 16 further comprising a step of tracking overflow conditions associated with a correctly rounded result of an arithmetic operation exceeding boundaries delimited by largest and smallest marks of marks of said pair of marks of a digital scale.

38. The method of claim 37 wherein said tracking of the overflow conditions requires a token representing an unbounded end point of said representation of said unbounded modal intervals to be exactly convertible between digital scales of a variety of digital scales in furtherance of mixed digital scale computing.

39. The improved interval computational methodology of claim 26 wherein a negative one is substituted for the NaN otherwise returned for division of marks representing unbounded modal interval end points comprised of infinities of opposite sign.

40. A computer executable interval computation method utilizing as inputs modal intervals comprised of a pair of a bit patterns associated with marks of a pair of marks of a digital scale, said method comprising:
a. representing bounded, unbounded, and pointwise modal intervals of said modal intervals within a computer system, the unbounded modal intervals characterized by a token representing an unbounded end point of at least a single mark of said pair of marks of a digital scale.
